(19) United States
(12) Patent Application Publication
(10) Pub. No.: US 2024/0181890 A1
(43) Pub. Date: Jun. 6, 2024

(54) BATTERY PACK AUTO SENSING AND SWITCHING

(71) Applicant: Zimeno Inc., Livermore, CA (US)

(72) Inventor: Karan KAUSHIK, Fremont, CA (US)

(73) Assignee: Zimeno Inc., Livermore, CA (US)

(21) Appl. No.: 18/516,700

(22) Filed: Nov. 21, 2023

Related U.S. Application Data
(60) Provisional application No. 63/526,240, filed on Jul. 12, 2023.
(60) Provisional application No. 63/429,178, filed on Dec. 1, 2022.

(51) Int. Cl. B60L 3/00; B60L 3/04

(52) U.S. Cl. CPC B60L 3/0046; B60L 3/04; B60L 2240/547

(57) ABSTRACT

A battery pack auto sensing and switching system may include a vehicle having an electric motor to propel the vehicle, a battery pack and a controller. The battery pack includes a first battery set and a second battery set. The controller is configured to concurrently electrically connect the first battery set and the second battery set to the electric motor; and determine a fault condition with respect to the first battery set. In response to the fault condition, the controller is configured to electrically disconnect the first battery set from the electric motor.

### CROSS-REFERENCE TO RELATED APPLICATIONS

The present non-provisional application claims priority from co-pending U.S. provisional patent Application Ser. No. 63/429,178 filed on Dec. 1, 2022, by Karan Kaushik and entitled BATTERY PACK AUTO SENSING AND SWITCHING, and co-pending U.S. provisional patent Application Ser. No. 63/526,240 filed on Jul. 12, 2023, by Karan Kaushik et al. and entitled VEHICLE CONTROL, the full disclosures of which are hereby incorporated by reference.

### BACKGROUND

Batteries are sometimes used to provide electrical power for propelling a vehicle. The batteries may power additional operations of such vehicles. Due to large power demands, such vehicles may include large battery packs.

### BRIEF DESCRIPTION OF THE DRAWINGS

FIG. 1 is a diagram schematically illustrating portions of an example vehicle with example battery pack auto sensing and switching system.

FIG. 2 is a flow diagram of an example battery pack auto sensing and switching method.

FIG. 3 is a flow diagram of an example battery pack auto sensing and switching method.

FIG. 4 is a diagram battery pack auto sensing and switching system.

FIG. 5 is a flow diagram of an example vehicle with an example battery pack auto sensing and switching method.

FIG. 6 is a flow diagram of an example battery pack auto sensing and switching method.

FIG. 7 is a flow diagram of an example battery pack auto sensing and switching method.

FIG. 8 is a perspective view of an example vehicle with an example battery pack auto sensing and switching system.

FIG. 9 is a sectional view of the example vehicle in the example battery pack auto sensing and switching system of FIG. 8.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example vehicle control systems in the form of example battery pack auto sensing and switching systems, methods and vehicles. The example battery pack auto sensing and switching systems, methods and vehicles include multiple battery sets which are concurrently electrically connected to an electric motor so as to concurrently provide electrical power to the electrical motor. The electrical motor provides electrical power for propelling the electric vehicle. The example battery pack auto sensing and switching systems, methods and vehicles monitor fault conditions and electrically disconnect a portion of the battery sets from the electric motor in response to a detected or determined fault condition.

In some implementations, the fault condition which may result in one of the battery sets being automatically disconnected from the electric motor are not limited to a temperature value exceeding a predetermined temperature threshold. In some implementations, the fault condition may comprise a voltage value associated with one of the battery sets that exceeds a predetermined maximum voltage threshold or that falls below a predetermined minimum voltage threshold. The voltage value may be a voltage value for an individual battery cell of a battery set. The voltage value may be in output voltage for a battery set. In some implementations, the fault condition may comprise a battery sets cell voltage sampling line break. In some implementations, the fault condition may comprise a battery set cell temperature sampling break. In some implementations, the fault condition may comprise an internal communication loss within a battery management system. In some implementations, the fault condition may comprise a communications loss between the battery management system and a vehicle control unit. In some implementations, the fault condition may comprise an electrical current associated with a battery set failing to satisfy a predetermined criterion. In some implementations, the fault condition may comprise a failure of a relay associated with a battery set. In yet other implementations, the fault condition may comprise a fault that is a 100% powered derating. In some implementations, a battery set may be automatically disconnected from the electric motor in response to one or more of the above describe faults occurring or being present.

In some implementations, the example systems, methods and vehicles are configured to monitor the presence of the fault condition and to automatically reconnect a currently disconnected battery set to the electric motor to the electric motor in response to the fault condition longer being present. In some implementations reconnection of a currently disconnected battery set may depend upon a sensed or determined characteristic of the currently disconnected battery set and/or the currently connected battery set. For example, reconnection of a currently disconnected battery set to the electric motor may depend upon relative temperatures, voltages or other characteristics of the currently disconnected battery set and the currently connected battery set or sets.

In some implementations, reconnection of a previously disconnected battery set to the electric motor may depend upon the relative voltage levels of the different battery sets. For example, the previously disconnected battery set may be automatically re-connected to the electric motor such that both of the battery set supply electrical power to the motor in response to the fault condition no longer being present and the voltage difference between the battery sets being less than a predetermined voltage difference threshold. In circumstances where the fault condition no longer exists, where the voltage difference is greater than the predetermined voltage difference threshold and where the voltage of the previously disconnected battery set is greater than the currently connected battery set, the previously disconnected battery set may be reconnected to the electric motor while the currently connected battery set may be disconnected from the electric motor. In circumstances where the fault condition no longer exists, where the voltage difference is greater than the predetermined voltage difference threshold, and where the voltage of the previously disconnected battery set is less than the currently connected battery set, the previously disconnected battery set may remain disconnected from the electric motor while the currently connected battery set may remain connected to the electric motor.

In some implementations, the examples automatically limit power consumption by component of the vehicle in response to an identified fault condition and a disconnection of a battery set from the electric motor. In some implementations, the operator may be notified of the component for which power consumption is limited. For example, in some implementations, the component for which power is limited may comprise a hydraulic pump electrically powered by the electric motor or the electric motor itself. In such implementations, the examples may remove the limit in response to reconnection of the previously disconnected battery set to the electric motor.

In some implementations, the vehicle may comprise a charging terminal configured to be electrically connected to an external electrical power source. The charging terminal may in turn be electrically connected to either or both of the battery sets for electrically charging either or both of the battery sets by a controller and electrical switching circuitry. The charging of either or both of the battery sets may occur while either or both of the battery sets is electrically connected to the electric motor or while either or both of the battery sets is electrically disconnected from the electric motor.

In some implementations, the controller and/or electric switching circuitry may automatically disconnect a battery set from the charging terminal (and from the external power source) in response to a detected fault. In some implementations, a battery set that was automatically disconnected from the electric motor due to a detected fault may likewise be automatically disconnected from the charging terminal due to the detected fault. In such implementations, reconnection of the disconnected battery set to the charging terminal upon the fault no longer being present may depend upon the relative states of one or more parameters of the battery sets.

In some implementations, the controller and/or electric switching circuitry may automatically (or in response to operator authorization prompted via a notification from the controller) connect the first battery set and the second battery set to the charging terminal in response to a fault condition not being present with respect to either of the battery sets and the voltage difference between the battery sets being less than a predetermined voltage difference threshold. In such implementations, the controller and/or electric switching circuitry may disconnect the first battery set from the charging terminal and connect the second battery set to the charging terminal in response to a fault condition no longer being present on either of the battery sets, the voltage difference between the battery sets being greater than the predetermined voltage difference threshold, and the first voltage being greater than the second voltage. In such implementations, the controller and/or electric switching circuitry may disconnect the second battery set from the charging terminal and connect the first battery set to the charging terminal in response to a fault condition no longer being present on either of the battery sets, the voltage difference being greater than the predetermined voltage difference threshold, and the second voltage being greater than the first voltage.

In some implementations, the controller and/or electric switching circuitry may automatically (or in response to operator authorization prompted via a notification from the controller) connect and disconnect the battery sets to and from the electric motor and the charging terminal based upon the relative voltage levels of the battery sets. For example, in response to a fault condition not being present on either of the two batteries, and in response to a voltage difference between the battery sets being less than the predefined voltage difference threshold, the controller and/or electric switching circuitry may automatically (or in response to operator authorization prompted via a notification from the controller) connect each of the battery sets to both the electric motor and the charging terminal. In response to a fault condition not being present on either of the two battery sets, and in response to a the voltage of the first battery set exceeding the voltage of a second battery set by an amount exceeding the predetermined voltage difference threshold, the controller and/or electric switching circuitry may automatically (or in response to operator authorization prompted via a notification from the controller) connect the first battery set to the electric motor, disconnect the first battery set from the charging terminal, connect the second battery set to the charging terminal and disconnect the second battery set from the electric motor. In response to a fault condition not being present on either of the two battery sets, and in response to a the voltage of the second battery set exceeding the voltage of a first battery set by an amount exceeding the predetermined voltage difference threshold, the controller and/or electric switching circuitry may automatically (or in response to operator authorization prompted via a notification from the controller) connect the second battery set to the electric motor, disconnect the second battery set from the charging terminal, connect the first battery set to the charging terminal and disconnect the first battery set from the electric motor.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

For purposes of this disclosure, the term “connection” or “connected” with respect to a battery set and an electric motor means that electrical power is being transmitted from the battery set to the electric motor. If both the battery sets are both already electrically connected to electric motor, electrical connection is simply maintained. For purposes of this disclosure, the term “connection” or “connected” with respect to a battery set and a charging terminal means that electrical power is capable of being transmitted from the charging terminal to the battery set. If both the battery sets are both already electrically connected to the charging terminal, electrical connection is simply maintained. For purposes of this disclosure, any phrase referring to a controller or electrical switching circuitry connecting a battery set to an electric motor or to a charging terminal means that the controller or electrical switching circuitry is changing a connection state to, or maintaining an existing connection state, where the battery set is connected to the electric motor or to the charging terminal. Likewise, any phrase referring to a controller or electric switching circuitry disconnecting a battery set from an electric motor or from a charging terminal means that the controller or electrical switching circuitry is changing a connection state to, or maintaining an existing disconnected state, where the battery set is disconnected from the electric motor or is disconnected from the charging terminal.

In some implementations, the examples automatically limit power consumption by component of the vehicle in response to an identified fault condition and a disconnection of a battery set from the electric motor. In some implementations, the operator may be notified of the component for which power consumption is limited. For example, in some implementations, the component for which power is limited may comprise a hydraulic pump electrically powered by the electric motor or the electric motor itself. In such implementations, the examples may remove the limit in response to reconnection of the previously disconnected battery set to the electric motor.

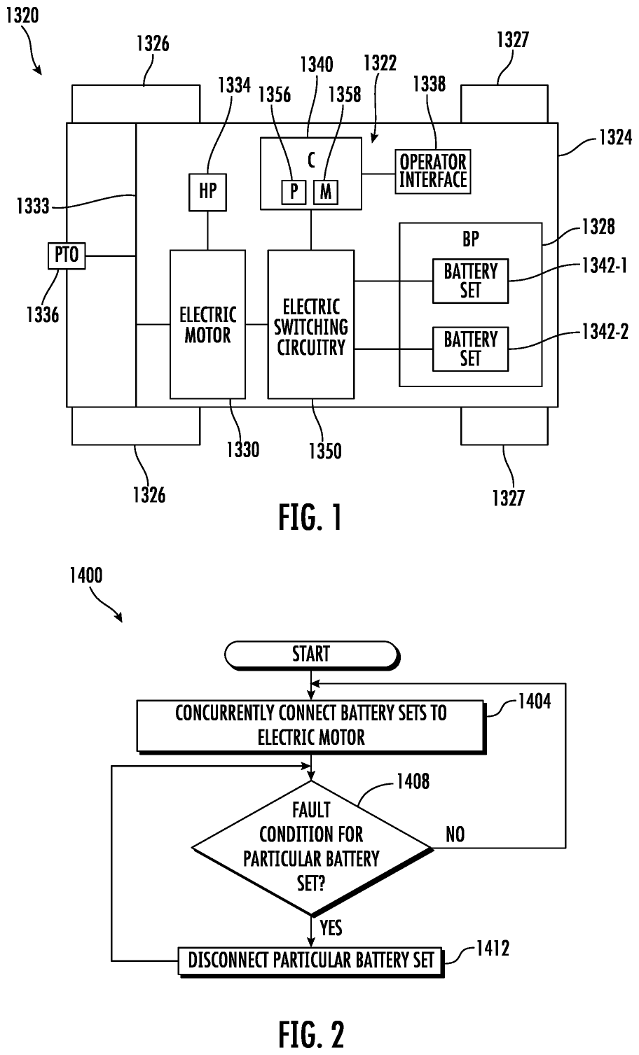

FIG. 1 is a diagram schematically illustrating portions of an example vehicle 1320 having an example battery pack auto sensing and switching system 1322. Vehicle 1320 comprises a self-propelled electrically powered vehicle. Examples of the vehicle 1320 include, but are not limited to, a tractor, a harvester, a truck, a passenger vehicle and the like. Vehicle 1320 comprises frame 1324 rotatably supporting rear driven traction members 1326 and front traction members 1327. Rear driven traction members 1326 may comprise wheels or tracks and are configured to engage the ground and drive or propel vehicle 1320 forwardly. The front traction members 1327 are configured to be steered for steering vehicle 1320. In some implementations, front traction members 1327 may also be driven, such as with a hydraulic motor driven by a hydraulic pump. Vehicle 1020 further comprises battery pack 1328, electric motor 1330, transmission 1333, hydraulic pump 1334, power takeoff 1336, operator interface 1338 and controller 1340.

Battery pack 1328 supplies electrical power for powering electric motor 1330. Battery pack 1328 may additionally supply electrical power to other components of vehicle 1320. Battery pack 1328 comprises battery sets 1342-1 and 1342-2 (collectively referred to as battery sets 1342). Each of battery sets 1342 is of a sufficient size and has sufficient electrical storage capacity to independently provide sufficient power for electric motor 1330 to propel vehicle 1320, to transmit torque through transmission 1332 to drive rear traction members 1326. The size of each of battery sets 1342 may vary depending upon the size and weight and power consumption demands of vehicle 1320. Although two battery sets 1342 are shown, battery pack 1328 may comprise additional battery sets.

Each of battery sets 1342 may comprise individual batteries or cells for supplying electrical charge. The batteries or cells of battery sets 1342 may be rechargeable. In some implementations, the battery cells may comprise lithium batteries.

Each of such battery sets 1342 may have associated operational limits, states at which such batteries may be susceptible to damage or severely hampered performance. Such limits may involve the temperature of the battery, the maximum charge of the battery, the maximum voltage of the battery and the like. Each of such battery sets may have associated sensors for outputting signals indicating the current temperature, voltage and other characteristics of the set of batteries or individual cells or batteries of the battery set. Examples of such sensors associated with battery sets 1342 include: negative temperature coefficient (NTC) thermistors, hall effect current sensors and voltage measurement circuits.

Electric motor 1330 receives electrical power from battery pack 1328 and torque for transmission of various consuming components of vehicle 1320. Transmission 1332 transmits torque from electric motor 1330 to drive traction members 1326 to propel vehicle 1320. Transmission 1333 may comprise various gear trains, clutches and other mechanisms for mechanically transmitting torque from electric motor 1330 to traction members 1326. In some implementations, transmission 1332 may additionally transmit torque from electric motor 1330 to hydraulic pump 1334 and power takeoff 1336.

Hydraulic pump 1334 receives torque from electric motor 1330 and supplies a pressurized hydraulic flow for driving various hydraulically driven components of vehicle 1320 and/or any attachments or implements. Hydraulic pump 1334 may supply a pressurized hydraulic flow to drive a hydraulic motor which drives front traction members 1327. Hydraulic pump 1334 may supply pressurized hydraulic flow to hydraulic cylinder-piston assemblies or hydraulic jacks to perform such functions as raising and lowering a front loader, a rear loader. Hydraulic pump 1334 may supply pressurized hydraulic flow to hydraulic cylinder-piston assemblies or other hydraulic driven components of an implement or attachment/tool carried by vehicle 1320. In some implementations, hydraulic pump 1334 may be omitted.

Power takeoff (PTO) 1336 provides torque to external implement or attachments. Transmission 1333 is configured to transmit torque from electric motor 1330 to PTO 1336. In some implementations, PTO 1336 may be omitted.

Operator interface 1338 comprises a device or components configured to interface with an operator, local or remote, of vehicle 1320. Although operator interface 1338 is illustrated as being carried by frame 1324. In some implementations, operator interface 1338 may be remote, wherein operator interface 1338 allows a remote operator to communicate with controller 1340 in a wireless fashion. Examples of operator interface 1338 include, but are not limited to, a touchscreen, a monitor with a cursor movable with a keyboard, joystick, mouse or the like, a pushbutton, slide bar, a switch or the like.

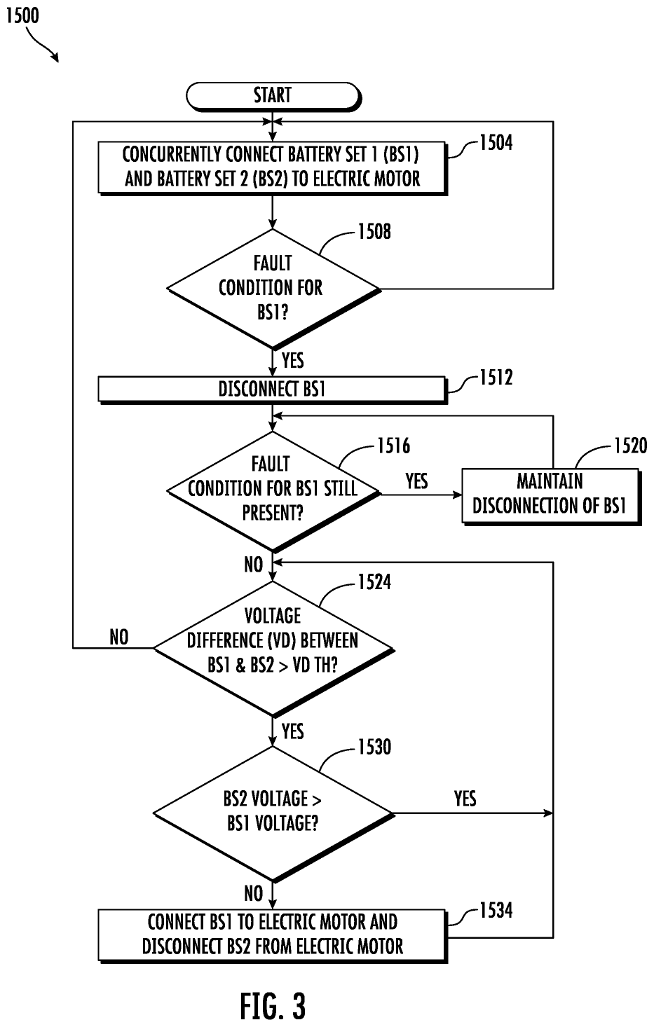

Controller 1340 comprises a processing unit 1356 and memory 1358. Processing unit 1356 receives data (in the form of signals) from various sensors, such as those sensors associated with battery sets 1342, carries out analysis or computations based upon such data, and outputs control signals based upon such data. Memory 1358 comprises a non-transitory computer-readable medium containing instructions configured to direct processor 1356 to carry out various programs or methods such as the methods described hereafter with respect to FIGS. 2 and 3.

Battery pack auto sensing and switching system 1322 monitors fault conditions and electrically disconnects one of the battery sets 1342 from the electric motor 1330 in response to a detected or determined fault condition. System 1322 comprises electric switching circuitry 1350 and controller 1340 (described above). Electric switching circuitry 1350 comprises electrical or electronic components, including electrical or electronic switches configured to operate between different states including: (1) concurrent electrical connection of both of battery sets 1342 to electric motor 1330 such that electrical charge is provided by both of battery sets 1342 to electric motor 1330; (2) electrical connection of battery set 1342-1 to electric motor 1330 while battery set 1342-2 is disconnected from electric motor 1330; and (3) electrical connection of battery set 1342-2 to electric motor 1330 while battery set 1342-1 is disconnected from electric motor 1330. Electrical switching circuitry 1350 is controllably actuatable between each and any of the three different states in response to control signals from processor 1356 of controller 1340. In one example implementation, electrical switching circuitry 1350 comprises opening of both positive and negative side contactors of a battery set.

Controller 1340 is part of a battery management system that manages the operation of battery sets 1342. Controller 1340 receives data or signals from the sensors associated with the battery sets 1342 and evaluates such signals to determine whether a fault condition with respect to either the battery sets 1342 exists or is present. In response to a detected fault condition, controller 1340 outputs electrical control signals actuating electric switching circuitry 1350 to a particular one of the states described above. For example, in the absence of a fault condition, controller 1340 outputs control signals causing electric switching circuitry 1350 to concurrently connect both the battery sets 1342 to electric motor 1330. In response to determining that a fault condition is present with respect battery set 1342-1, controller 1340 may output control signals to electric switching circuitry 1350 causing circuitry 1350 to electrically disconnect battery set 1342-1 from electric motor 1330, continuing to permit battery set 1342-2 to power electric motor 1330. In response to determining that a fault condition is present with respect to battery set 1342-2, controller 1340 may output control signals to electrical switching circuitry 1350 to electrically disconnect battery set 1342-1 from electric motor 1330, continuing to permit battery set 1342-2 to power electric motor 1330.

In some implementations, the fault condition which may result in one of the battery sets 1342 being automatically disconnected from the electric motor 1330 include, but are not limited to, a temperature value exceeding a predetermined temperature threshold. In some implementations, the fault condition may comprise a voltage value associated with one of the battery sets that exceeds a predetermined maximum voltage threshold or that falls below a predetermined minimum voltage threshold. The voltage value may be a voltage value for an individual battery cell of a battery set 1342. The voltage value may be an output voltage for a battery set. In some implementations, the fault condition may comprise a battery sets cell voltage sampling line break. In some implementations, the fault condition may comprise a battery sets cell temperature sampling break. In some implementations, the fault condition may comprise an internal communication loss within a battery management system. In some implementations, the fault condition may comprise a communications loss between the battery management system and a vehicle control unit. In some implementations, the fault condition may comprise an electrical current associated with a battery set failing to satisfy a predetermined criterion. In some implementations, the fault condition may comprise a failure of a relay associated with a battery set. In yet other implementations, the fault condition may comprise a fault that is 100% power derating. In some implementations, a battery set may be automatically disconnected from the electric motor in response to one or more of the above describe faults occurring or being present.

In some implementations, controller 1340 is configured to monitor the presence of the fault condition and to automatically reconnect a previously disconnected battery set in response to the fault condition longer being present. In some implementations, reconnection of a previously disconnected battery set may depend upon the relative voltage levels of the different battery sets 1342. For example, the previously disconnected battery set may be automatically re-connected to the electric motor such that both of the battery set supply electrical power to the motor in response to the fault condition no longer being present and the voltage difference between the battery sets being less than a predetermined voltage difference threshold. In circumstances where the fault condition no longer exists and where the voltage difference is greater than the predetermined voltage difference threshold and wherein the voltage of the previously disconnected battery set is greater than the currently connected battery set, the previously disconnected battery set may be reconnected to the electric motor while the currently connected battery set may be disconnected from the electric motor. In circumstances where the fault condition no longer exists and where the voltage difference is greater than the predetermined voltage difference threshold and wherein the voltage of the previously disconnected battery set is less than the currently connected battery set, the previously disconnected battery set may remain disconnected from the electric motor while the currently connected battery set may remain connected to the electric motor.

In some implementations, controller 1340 may automatically limit power consumption by component of the vehicle 1320. In response to an identified fault condition and a disconnection of a battery set from the electric motor. In some implementations, the operator may be notified of the component for which power consumption is limited via operator interface 1338. For example, in some implementations, the component for which power is limited may comprise a hydraulic pump 1334 electrically powered by the electric motor 1330 or the electric motor 1330 itself. In such implementations, controller 1340 may remove the limit in response to reconnection of the previously disconnected battery set to the electric motor 1330. In some implementations, rather than automatically switching the connection of battery sets 1342 to electric motor 1330, controller 1340 may prompt an operator to confirm or authorize such a switching operation through the use of operator interface 1338.

FIG. 2 a flow diagram of an example method 1400 that may be carried out by controller 1340 of vehicle 1320 or by other controllers of other vehicles. As indicated by block 1404, controller 1340 outputs control signals (or does not output control signals maintaining a status quo) so as to concurrently connect battery sets 1342 to electric motor 1330. As result, both battery sets 1342 supply electrical power to electric motor 1330 for propelling vehicle 1320, for driving rear driven traction members 1326.

As indicated by block 1408, controller 1340 continues to monitor for fault conditions on each of the battery sets 1342. Such monitoring involves polling or otherwise receiving data or signals from sensors associated with battery sets 1342 which might indicate a fault condition.

In some implementations, the fault condition which may result in one of the battery sets 1342 being automatically disconnected from the electric motor 1330 are not limited to a temperature value exceeding a predetermined temperature threshold. In some implementations, the fault condition may comprise a voltage value associated with one of the battery sets that exceeds a predetermined maximum voltage threshold or that falls below a predetermined minimum voltage threshold. The voltage value may be a voltage value for an individual battery cell of a battery set 1342. The voltage value may be in output voltage for a battery set. In some implementations, the fault condition may comprise a battery sets cell voltage sampling line break. In some implementations, the fault condition may comprise a battery sets cell temperature sampling break. In some implementations, the fault condition may comprise an internal communication loss within a battery management system. In some implementations, the fault condition may comprise a communications loss between the battery management system and a vehicle control unit. In some implementations, the fault condition may comprise an electrical current associated with a battery set failing to satisfy a predetermined criterion. In some implementations, the fault condition may comprise a failure of a relay associated with a battery set. In yet other implementations, the fault condition may comprise a fault that is 100% powered the rating. In some implementations, a battery set may be automatically disconnected from the electric motor in response to one or more of the above describe faults occurring or being present.

As indicated by block 1412, in response to a fault condition being detected on one of the battery sets 1342, controller 1340 outputs control signals to electric switching circuitry 1350 to disconnect the particular battery set which has the associated fault condition.

FIG. 3 is a flow diagram of an example method 1500 that may be carried out by controller 1340 of vehicle 1320 or by other vehicles. As indicated by block 1504, controller 1340 outputs control signals (or does not output control signals maintaining a status quo) so as to concurrently connect battery sets 1342 to electric motor 1330. As result, both battery sets 1342 supply electrical power to electric motor 1330 for propelling vehicle 1320, for driving rear driven traction members 1326.

As indicated by block 1508, controller 1340 continues to monitor for fault conditions on each of the battery sets 1342. Such monitoring involves polling or otherwise receiving data or signals from sensors associated with battery sets 1342 which might indicate a fault condition. Although method 1500 is described in the context of monitoring for a fault condition present on the first battery set, the “first battery set” may comprise either of battery sets 1342-1 or 1342-2. In other words, controller 40 monitors and may adjust the connection for both of the individual battery sets 1342.

In some implementations, the fault condition which may result in one of the battery sets 1342 being automatically disconnected from the electric motor 1330 is not limited to a temperature value exceeding a predetermined temperature threshold. In some implementations, the fault condition may comprise a voltage value associated with one of the battery sets that exceeds a predetermined maximum voltage threshold or that falls below a predetermined minimum voltage threshold. The voltage value may be a voltage value for an individual battery cell of a battery set 1342. The voltage value may be in output voltage for a battery set. In some implementations, the fault condition may comprise a battery set cell voltage sampling line break. In some implementations, the fault condition may comprise a battery set cell temperature sampling break. In some implementations, the fault condition may comprise an internal communication loss within a battery management system. In some implementations, the fault condition may comprise a communications loss between the battery management system and a vehicle control unit. In some implementations, the fault condition may comprise an electrical current associated with a battery set failing to satisfy a predetermined criterion. In some implementations, the fault condition may comprise a failure of a relay associated with a battery set. In yet other implementations, the fault condition may comprise a fault that is 100% power derating. In some implementations, a battery set may be automatically disconnected from the electric motor in response to one or more of the above describe faults occurring or being present.

As indicated by block 1512, in response to a fault condition being detected on one of the battery sets 1342, controller 1340 outputs control signals to electric switching circuitry 1350 to disconnect the particular battery set which has the associated fault condition.

As indicated by block 1516, controller 1340 is configured to monitor the presence of the fault condition and to automatically reconnect a previously disconnected battery set in response to the fault condition longer being present. As indicated by block 1520, response to a fault condition continuing to be present, the disconnected state of the particular battery set BS1 is maintained. In some implementations, upon a determination by controller 1340 that the fault condition is low longer present with respect to the particular battery set BS1, the previously disconnected battery set BS1 is automatically re-connected to the electric motor 1330, regardless or independent of other conditions or factors.

In the illustrated example, reconnection of a previously disconnected battery set is dependent upon the relative voltage levels of the different battery sets 1342. As indicated by block 1524, upon determining that a fault condition on the particular battery set BS1 is no longer present, controller 1340 evaluates a voltage difference between battery sets 1342-1 and 1342-2. As indicated by arrow 1526, in response to the voltage difference not satisfying or not exceeding a predefined voltage difference threshold, controller 1340 returns to block 1504, where controller 1340 outputs control signals such that both of battery sets BS1 and BS2 are concurrently electrically connected to electric motor 1330. In other words, the previously disconnected battery set BS1 is reconnected to electric motor 1330.

As indicated by blocks 1530 and 1534, in response to the voltage difference exceeding the predefined voltage difference threshold, controller 1340 evaluates or determines which of the two battery sets 1342-1, 1342-2, has a larger voltage level. As indicated by block 1530, in response to the voltage difference being greater than the predetermined voltage difference threshold and the voltage of the currently connected battery set BS2 being greater than the previously disconnected battery set BS1, the previously disconnected battery set BS1 remains disconnected, permitting the voltage of BS2 to be further drawn down to reduce the voltage difference. As a voltage of BS2 continues to be lowered, controller 1340 continues to monitor the voltage difference between the two battery sets 1342 as indicated by block 1524. As indicated by block 1534, in response to the voltage of the currently connected battery set BS2 being less than the previously disconnected battery set BS1 (the voltage of battery set BS1 is greater than the voltage of battery set BS2), the previously disconnected battery set may be reconnected to the electric motor (to allow the voltage of battery BS1 to be lowered) while the currently connected battery set may be disconnected from the electric motor. Once again, controller 1340 continues to monitor the voltage difference between battery sets 1342-1 and 1342-2. As indicated by arrow 1526 and block 1504, once the voltage difference is less than the predefined voltage difference threshold, both of battery sets 1342 are concurrently connected to electric motor 1330.

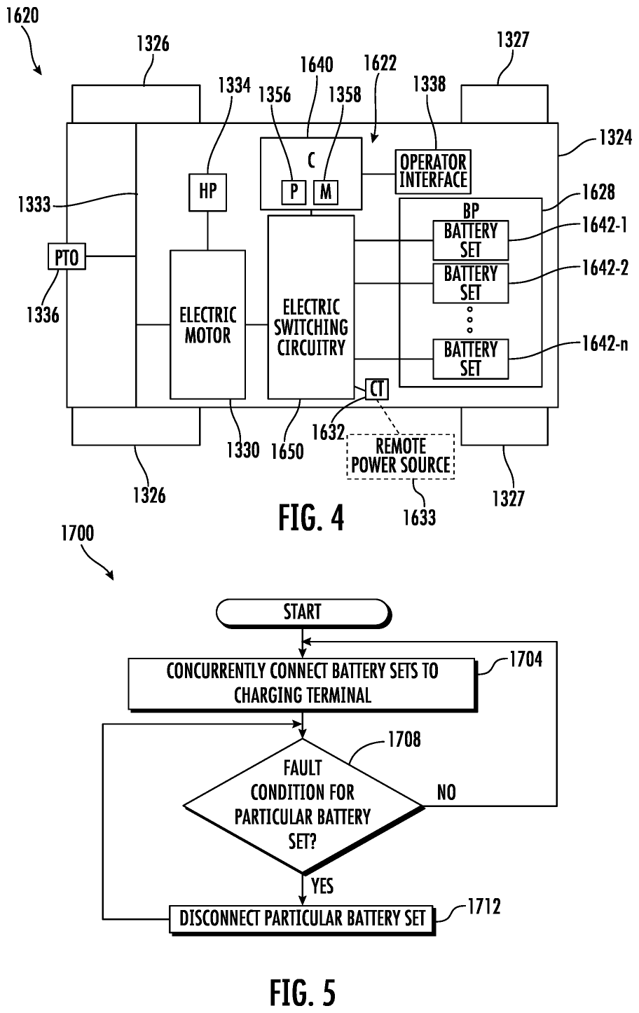

FIG. 4 is a diagram schematically illustrating portions of an example vehicle 1620 with an example battery pack auto sensing and switching system 1622. Vehicle 1620 is similar to vehicle 20 described above except that vehicle 1620 comprises battery pack 1628 which comprises battery sets 1642-1, 1642-2, . . . 1642-n (collectively referred to as battery sets 1642) and further comprises charging terminal 1632. System 1622 comprises controller 1640 and electric switching circuit 1650. Those remaining components of vehicle 1620 and system 1622, which correspond to components of vehicle 1320 and system 1322 are numbered similarly.

Battery sets 1642 are similar to battery sets 1342 described above. In some implementations, each individual battery set 1642 is sized and configured to independently power electric motor 1330 to propel vehicle 1620. In some implementations, a particular individual battery sets 1642 may not be configured to independently provide enough power to the motor 1330 for propelling vehicle 1620, but when combined with one or more of the other battery sets, is configured to supply sufficient power for electric motor 1330 to propel vehicle 1620. For example, in one example implementation, battery set 1642-1 may be configured to independently power electric motor 1330, by itself, to an extent sufficient to propel vehicle 1620. Battery sets 1642-3-1642-n, when combined or concurrently connected to motor 1330, may collectively supply sufficient power to electric motor 1330 for propelling vehicle 1620. Supply of electric power from each of battery sets 1642 to electric motor 1330 is controlled by system 1622 which comprise controller 1640 and electric switching circuitry 1650.

Charging terminal 1632 comprises a port, plug or other connection configured for being releasably connected to a remote or external power source 1633 (shown in broken lines). Charging terminal 1632 is selectively connectable to each and any of battery sets 1642 by controller 1640 and electric switching circuitry 1350 for individually charging the battery sets 1642. The remote power source 1633 may be provided at a geographically fixed charging station or may be provided by a portable charging vehicle or trailer.

As in system 1322, in system 1622, controller 1640 monitors battery pack 1628 and various components associated with battery pack 1628 to identify faults with individual battery sets or with particular groupings of the total number of battery sets. In response to a detected fault on one of the particular battery sets or a number of particular battery sets, controller 1640 and electric switching circuitry 1650 may automatically (or in response to operator input/authorization prompted by controller 1640 on operator interface 1338) disconnect those particular battery sets, for which default has been identified, from the electric motor 1330.

As described above with respect to method 1500, controller 1640 may further monitor the state of any previously detected fault. In response to the fault (or faults) no longer being present, controller 1640 may automatically (or in response to operator input/authorization prompted by controller 1640 on operator interface 1338) reconnect the previously disconnected battery set or sets 1642 to the electric motor 1330. As described above with respect to method 1500, such reconnection by the controller 1340 may be contingent upon a controller monitored voltage difference between the different battery sets 1642.

In some implementations, the voltage of each currently disconnected individual battery set 1642 is compared to an average voltage of the currently connected battery sets of pack 1628. In some implementations, the voltage of each currently disconnected individual battery sets 1642 is compared to the voltage of the individual currently connected battery set 1642 having a voltage closes to that of the currently disconnected individual battery set 1642. In some implementations, the voltage of each currently disconnected individual battery set 1642 is compared to the voltage of the individual currently connected battery set 1642 having a voltage most different than that of the currently disconnected individual battery sets 1642. In yet other implementations, other voltage comparisons between one or more currently connected battery sets and one or more currently disconnected battery sets may be performed by controller 1640 to determine whether the one or more currently disconnected battery sets should be reconnected and whether the one or more currently connected battery sets should be disconnected.

In the illustrated example, the currently disconnected battery set may be reconnected to the electric motor 1330 in response to the voltage difference not exceeding the predetermined voltage difference threshold. In response to the currently disconnected battery set having a voltage greater than the voltage of the connected battery sets and the voltage difference exceeding the predetermined voltage difference threshold, the currently disconnected battery may be connected to the electric motor 1330 and at least one of the currently connected battery sets may be disconnected from the electric motor. In response to the currently disconnected battery set having a voltage less the voltage of the connected battery sets and the voltage difference exceeding than the predetermined voltage difference threshold, the currently disconnected battery may be maintained in a disconnected state from the electric motor 1330. In some implementations, each individual battery set 1642 or particular groups of battery sets 1642 may have different associated voltage difference thresholds for used by controller 1340 when determining when to reconnect battery set to electric motor 1330 or when to disconnected battery set from electric motor 1330.

Controller 1640 and electric switching circuitry 1650 of system 1622 are further configured to selectively and individually disconnect and connect the battery sets 1642 from and to charging terminal 1632 based upon a detected fault in at least one of the battery sets 1642. In the example illustrated, medium or memory 1358 may contain instructions directing processor 1356 to carry out the example method 1700 shown in FIG. 5.

As indicated by block 1704, controller 1640 outputs control signals (or does not output control signals maintaining a status quo) so as to concurrently connect battery sets 1642 to charging terminal 1632. As result, each of battery sets 1642 may be electrically charged by a remote power source 1633 when remote power source 1633 is connected to terminal 1632.

As indicated by block 1708, controller 1340 continues to monitor for fault conditions on each of the battery sets 1642. Such monitoring involves polling or otherwise receiving data or signals from sensors associated with battery sets 1642 which might indicate a fault condition.

In some implementations, the fault condition which may result in one of the battery sets 1642 being automatically disconnected from the charging terminal 1632 is not limited to a temperature value exceeding a predetermined temperature threshold. In some implementations, the fault condition may comprise a voltage value associated with one of the battery sets that exceeds a predetermined maximum voltage threshold or that falls below a predetermined minimum voltage threshold. The voltage value may be a voltage value for an individual battery cell of a battery set 1642. The voltage value may be in output voltage for a battery set. In some implementations, the fault condition may comprise a battery sets cell voltage sampling line break. In some implementations, the fault condition may comprise a battery sets cell temperature sampling break. In some implementations, the fault condition may comprise an internal communication loss within a battery management system. In some implementations, the fault condition may comprise a communications loss between the battery management system and a vehicle control unit. In some implementations, the fault condition may comprise an electrical current associated with a battery set failing to satisfy a predetermined criterion. In some implementations, the fault condition may comprise a failure of a relay associated with a battery set. In yet other implementations, the fault condition may comprise a fault that is 100% power derating. In some implementations, a battery set may be automatically disconnected from the charging terminal in response to one or more of the above describe faults occurring or being present.

As indicated by block 1712, in response to a fault condition being detected on one of the battery sets 1642, controller 1340 outputs control signals to electric switching circuitry 1350 to disconnect the particular battery set which has the associated fault condition from the charging terminal 1632.

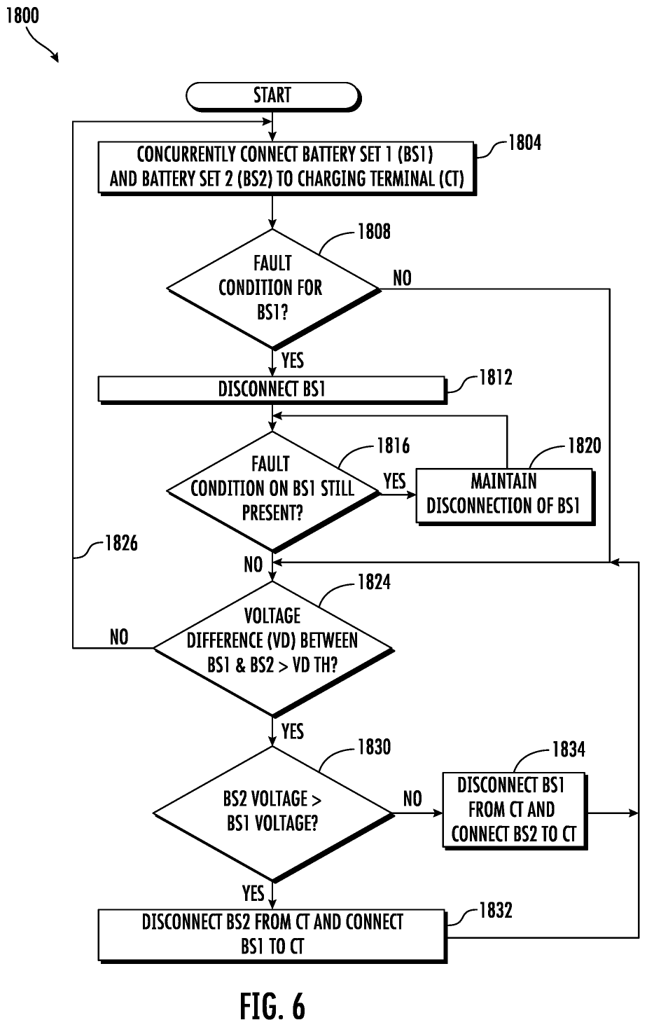

FIG. 6 is a flow diagram of an example method 1800 that may be carried out by controller 1340 of vehicle 1620 or by other vehicles. As indicated by block 1804, controller 1340 outputs control signals (or does not output control signals maintaining a status quo) so as to concurrently connect battery sets 1642 to charging terminal 1632. As result, each of battery sets 1642 may be electrically charged by a remote power source 1633 when remote power source 1633 is connected to terminal 1632.

As indicated by block 1808, controller 1340 continues to monitor for fault conditions on each of the battery sets 1642. Such monitoring involves polling or otherwise receiving data or signals from sensors associated with battery sets 1642 which might indicate a fault condition. Examples of such conditions are described above with respect to method 1700.

As indicated by block 1812, in response to a fault condition being detected on one or more of the battery sets 1642, controller 1340 outputs control signals to electric switching circuitry 1350 to disconnect the one or more battery sets BS1, which have an associated fault condition, from the charging terminal 1632.

As indicated by block 1816, controller 1340 is configured to monitor the presence of the fault condition and to automatically reconnect a previously disconnected battery set in response to the fault condition longer being present. As indicated by block 1820, response to a fault condition continuing to be present, the disconnected state of the particular battery set BS1 with respect to charging terminal 1632 is maintained. In some implementations, upon a determination by controller 1340 that the fault condition is low longer present with respect to the particular battery set BS1, the previously disconnected battery set BS1 is automatically re-connected to the charging terminal 1632, regardless or independent of other conditions or factors.

In the illustrated example, reconnection of a previously disconnected battery set is dependent upon the relative voltage levels of the different battery sets 1642. As indicated by block 1824, upon determining that a fault condition on the particular battery set BS one is no longer present, controller 1340 evaluates a voltage difference between battery sets 1642 or between groupings of battery sets 1642. As indicated by arrow 1826, in response to the voltage difference not satisfying or not exceeding a predefined voltage difference threshold, controller 1340 returns to block 1804, where controller 1340 outputs control signals such that all of battery sets 1642 are concurrently electrically connected to charging terminal 1632. In other words, the previously disconnected battery set BS1 (and any additional previously disconnected battery sets) is reconnected to charging terminal 1632.

As indicated by block 1830, in response to the voltage difference exceeding the predefined voltage difference threshold, controller 1340 evaluates or determines which of the connected and disconnected battery sets 1642 has a larger voltage level. As indicated by block 11832, in response to the voltage difference being greater than the predetermined voltage difference threshold and wherein the voltage of the currently connected battery set BS2 is greater than the previously disconnected battery set BS1, the currently connected battery set BS2 is disconnected and the currently disconnected battery set BS one is connected to the charging terminal 1632, permitting the voltage of BS1 to be increased to reduce the voltage difference. As a voltage of BS1 continues to be increased, controller 1340 continues to monitor the voltage difference between the two battery sets 1642 as indicated by block 1824.

As indicated by block 1834, in response to the voltage of the currently connected battery set BS2 being less than the previously disconnected battery set BS1 (the voltage of battery set BS1 is greater than the voltage of battery set BS2), the currently connected battery set BS2 may remain connected to the charging terminal 1632 (to allow the voltage of battery BS2 to be increased) while the currently disconnected battery set BS one remains disconnected from the charging terminal 1632. Once again, controller 1340 continues to monitor the voltage difference between battery sets 1642. As indicated by arrow 1826 and block 1804, once the voltage difference is less than the predefined voltage difference threshold, the battery sets are concurrently connected to charging terminal 1632.

As shown by FIG. 6, even in circumstances where no fault is detected by controller 1340, controller 1340 continues to monitor the voltage difference between the various battery sets 1642 of battery pack 1628 to determine which individual battery sets 1642 are to be connected to the charging terminal 1632 in which a battery set 1642 are to be disconnected from the charging terminal 1632. In some implementations, blocks 1808, 1812, 1816 1820 may be omitted from method 1800. In such implementations, method 1800 may be carried out by controller 1340 when vehicle 1620 is not being driven by electric motor 1330 but is only having its battery set 1642 charged.

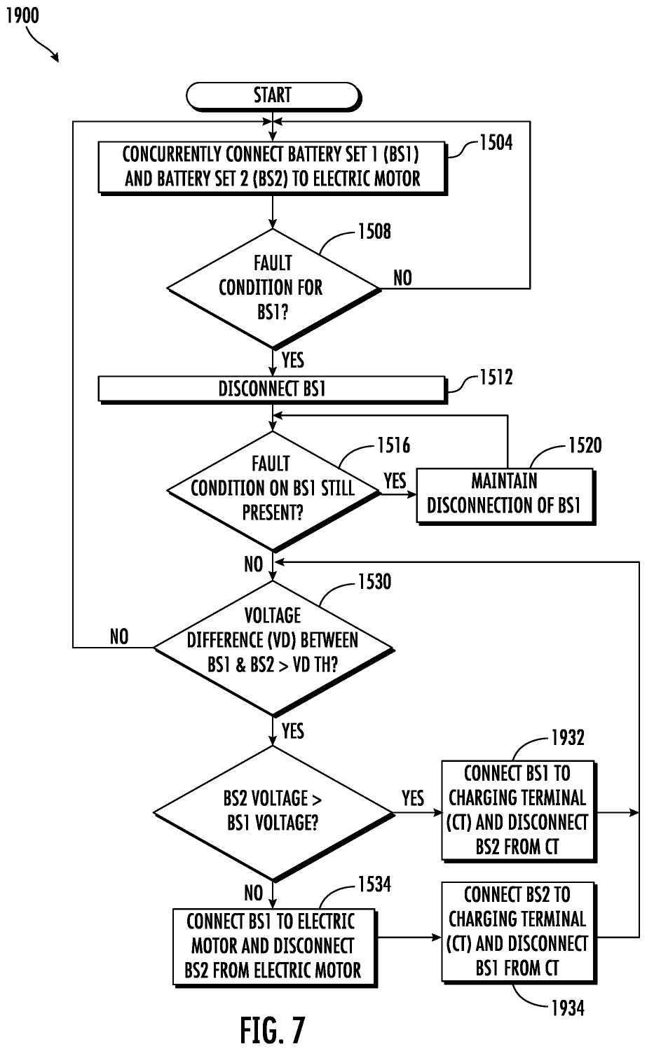

FIG. 7 is a flow diagram of an example battery pack auto sensing and switching system 1600 that may be carried out by vehicle 1620. Method 1900 is similar to method 1500 described above except that method 1900 additionally comprises blocks 1932 and 1934. Those remaining blocks or steps of method 1800 which correspond to blocks or sets of method 1500 are numbered similarly and are described above with respect to method 1500.

As indicated by block 1932, in response to the voltage of the battery set or sets BS2 currently connected to the electric motor 1330 being greater than the voltage of the battery sets BS1 currently disconnected from the electric motor 1330 and the voltage differential threshold being exceeded in block 1530, controller 1340 connects those battery sets BS 1 that are currently disconnected from the electric motor to the charging terminal 1632 and disconnects those battery sets BS2, that are the currently connected to the electric motor 1330, from charging terminal 1632. This may result in the voltage difference decreasing more quickly.

As indicated by block 1934, in response to the voltage of the battery set or sets BS2 currently connected to the electric motor 1330 being less than the voltage of the battery sets BS1 currently disconnected from the electric motor 1330 and the voltage differential being exceeded in block 1530, controller 1340 disconnects those battery sets BS 1 that are currently connected to the electric motor from the charging terminal 1632 and connects those battery sets BS2 that are the currently disconnected from the electric motor 1330, to charging terminal 1632. This may result in the voltage difference decreasing more quickly.

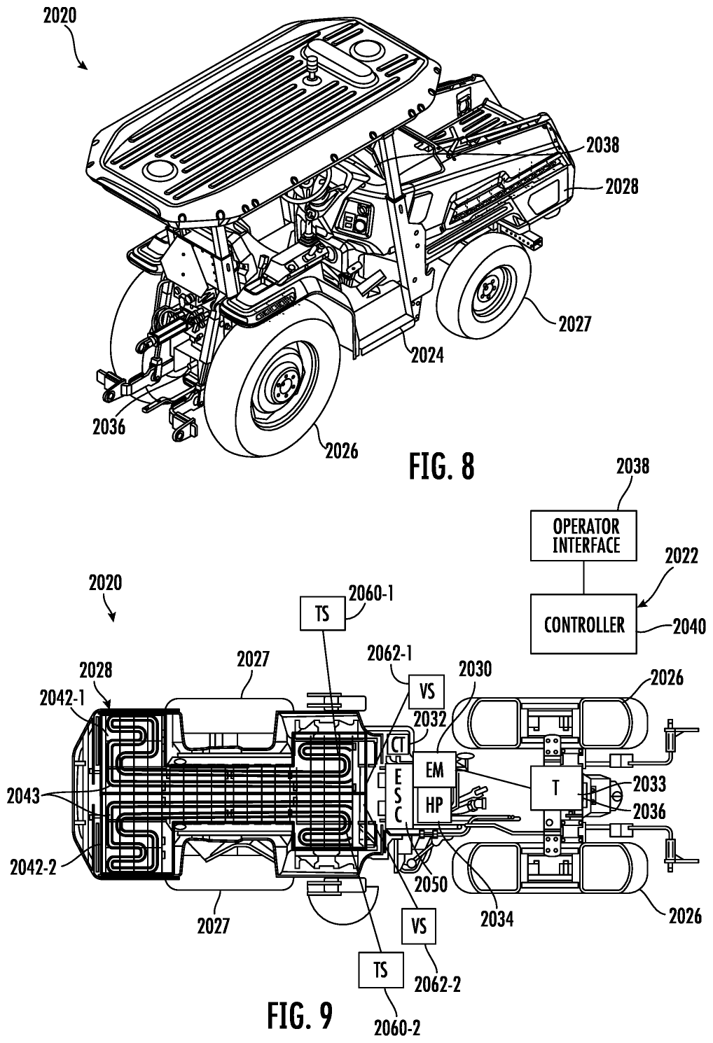

FIGS. 8 and 9 illustrate portions of an example vehicle 2020 in the form of an example tractor. Vehicle 2020 is part of an example battery pack auto sensing and switching system 2022. Vehicle 2020 comprises a self-propelled electrically tractor having a frame 2024 rotatably supporting rear driven traction members 1626 and front traction members 2027. Rear driven traction members 1626 may comprise wheels or tracks and are configured to engage the ground and drive or propel vehicle 2020 forwardly. The front traction members 1627 are configured to be steered for steering vehicle 2020. In some implementations, front traction members 2027 may also be driven, such as with a hydraulic motor driven by a hydraulic pump. Vehicle 1620 further comprises battery pack 2028, electric motor 2030, charging terminal 2032, transmission 2033, hydraulic pump 2034, power takeoff 2036, operator interface 2038 and controller 2040.

Battery pack 2028 supplies electrical power for powering electric motor 2030. Battery pack 2028 may additionally supply electrical power to other components of vehicle 2020. Battery pack 2028 comprises battery sets 2042-1 and 2042-2 (collectively referred to as battery sets 2042). Each of battery sets 2042 is of a sufficient size and has sufficient electrical storage capacity to independently provide sufficient power for electric motor 2030 to propel vehicle 2020, to transmit torque through transmission 2033 to drive rear traction members 2026. The size of each of battery sets 2042 may vary depending upon the size and weight and power consumption demands of vehicle 2020. Although two battery sets 2042 are shown, battery pack 2028 may comprise additional battery sets.

Each of battery sets 2042 may comprise individual batteries or cells for supplying electrical charge. The batteries a battery sets 2042 may be rechargeable. In some implementations, the battery cells may comprise lithium batteries. In the example illustrated, the individual batteries or cells of battery pack 2028 are configured to provide battery pack 2028 with a shape that extends both in front of and rearward of front traction members 2027, having an “I” shape when viewed from the top facilitating a larger number of battery units or cells beneath the front footprint of the tractor providing vehicle 2020. In the example illustrated, each of battery sets 2042 is provided with a cooling fluid manifold or circulation system 2043. Cooling fluid is related through system 2043 to extract or conduct heat from the individual batteries of battery sets 2042. In other implementations, battery pack 2028 and battery set 2042 may have other configurations and may be provided at other locations on vehicle 2020. In other implementations, circulation system 2043 may be omitted.

Each of such battery sets 2042 may have associated operational limits, states at which such batteries may be susceptible to damage or severely hampered performance. Such limits may involve the temperature of the battery, the maximum charge of the battery, the maximum voltage of the battery and the like. As schematically illustrated, battery sets 2042-1 and 2042-2 may have associated temperature sensors 2060-1, 2060-2 for outputting signals indicating the current temperature of battery sets 2042-1 and 2042-2, respectively. In some implementations, temperature sensors 2060 comprise a plurality of individual temperature sensors with each battery cell or individual battery having a dedicated temperature sensor. In some implementations, temperature sensor 1660 may comprise one or more temperature sensors that are provided at a predetermined location relative to the respective battery set 2042, wherein the number of temperature sensors is less than the number of individual batteries or battery cells and wherein values from the one or more temperature sensors are used by controller 2040 to determine a fault condition. In some implementations, each of battery sets 2042 may have one or more temperature sensors 2060 situated along its circulation system 2043 to sense the temperature of the fluid being circulated.

Examples of such sensors associated with battery sets 2042 include, but are not limited to, negative temperature coefficient (NTC) thermistors. In other implementations, temperature sensors 2060 may comprise other forms of temperature sensors that sense the temperature of air or materials/fluids adjacent to the batteries of battery set 2042 or that sense the temperature of the cooling fluid being circulated along circulation system 2043. Such temperature sensors are transmitted to controller 2040.

As further schematically illustrated by FIG. 9, each of battery sets 2042 is associated with a respective voltage sensor. Battery set 2042-1 is associated with a voltage sensor 2062-1 while battery set 2042-2 is associated with voltage sensor 2062-2 (voltage sensors 2062-1 and 2062-2 being collectively referred to as voltage sensors 2062). Voltage sensors 2062 output signals indicating the individual voltages or voltage levels of battery sets 2042. In some implementations, voltage sensors 2062 may comprise Hall effect current sensors and voltage measurement circuits.

Temperature sensors 2060 and voltage sensors 2062 communicate sensed values via signaling lines connected to controller 2040. Such allegedly conductive lines are used to transmit samplings of the temperatures and voltages of battery sets 1642 to controller 2040. As will be described hereafter, controller 2040 may determine that a fault condition exists based on the sensed temperatures, based upon the sensed voltages, or based upon a break or interruption in the transmission of either of the temperature signals (a temperature sampling line break) or voltage signals (a voltage sampling line break).

Electric motor 2030 receives electrical power from battery pack 1628 and outputs torque for transmission to various consuming components of vehicle 2020. Transmission 2033 transmits torque from electric motor 2030 to drive traction members 2026 to propel vehicle 2020. Transmission 2033 may comprise various gear trains, clutches and other mechanisms for mechanically transmitting torque from electric motor 2030 to traction members 2026. In some implementations, transmission 2033 may additionally transmit torque from electric motor 2030 to hydraulic pump 2034 and power takeoff 2036.

Charging terminal 2032 comprises a port, plug or other connection configured for being releasably connected to a remote power source 1633. Charging terminal 2032 is selectively connectable to each and any of battery sets 2042 by controller 2040 and electric switching circuitry 2050 for individually charging the battery sets 2042. The remote power source may be provided at a geographically fixed charging station or may be divided by portable charging vehicle or trailer.

Hydraulic pump 2034 receives torque from electric motor 2030 and supplies a pressurized hydraulic flow for driving various hydraulically driven components of vehicle 2020. Hydraulic pump 2034 may supply a pressurized hydraulic flow to drive a hydraulic motor which drives front traction members 2027. Hydraulic pump 2034 may supply pressurized hydraulic flow to hydraulic cylinder-piston assemblies or hydraulic jacks to perform such functions as raising and lowering a front loader, a rear loader. Hydraulic pump 2034 may supply pressurized hydraulic flow to hydraulic cylinder-piston assemblies or other hydraulic driven components of an implement or attachment/tool carried, pushed or pulled by vehicle 2020. In some implementations, hydraulic pump 2034 may be omitted.

Power takeoff (PTO) 2036 provides torque to external implement or attachments. Transmission 2033 is configured to transmit torque from electric motor 2030 to PTO 2036. In some implementations, PTO 2036 may be omitted.

Operator interface 2038 comprises a device or components configured to interface with an operator, local or remote, of vehicle 2020. Although operator interface 2038 is illustrated as being carried by frame 2024, in some implementations, operator interface 2038 may be remote, wherein operator interface 2038 allows a remote operator to communicate with controller 2040 in a wireless fashion. Examples of operator interface 2038 include, but are not limited to, a touchscreen, a monitor with a cursor movable with a keyboard, joystick, mouse or the like, a pushbutton, slide bar, a switch or the like.

Battery pack auto sensing and switching system 2022 monitors fault conditions and electrically disconnects one of the battery sets 2042 from the electric motor 2030 in response to a detected or determined fault condition. System 2022 comprises electric switching circuitry 2050 and controller 2040 (described above). Battery pack auto sensing and switching system 2022 also monitors fault conditions and electrically connects and disconnects one of the battery sets 2042 to and from charging terminal 2032 in response to a detected or determined fault condition. System 2022 comprises electric switching circuitry 2050 and controller 2040.

Electric switching circuitry 2050 comprises electrical or electronic components, including switches configured to operate between different motor connection states including: (1) concurrent electrical connection of both of battery sets 2042 to electric motor 2030 such that electrical charges provided by both of battery sets 2042 to electric motor 2030; (2) electrical connection of battery set 2042-1 to electric motor 2030 while battery set 2042-2 is disconnected from electric motor 2030; (3) electrical connection of battery set 2042-2 to electric motor 2030 while battery set 2042-1 is disconnected from electric motor 2030; and (4) concurrent disconnection of all of battery sets 2042 from motor 2030. Electric switching circuitry 2050 further comprises electrical or electronic components, including switches configured to operate between different charging terminal connection states including: (1) concurrent electrical connection of both of battery sets 2042 to charging terminal 2032 such that both of battery sets 2042 may be electrically charged when terminal 2032 is connected to an external power source; (2) electrical connection of battery set 2042-1 to charging terminal 2032 while battery set 2042-2 is disconnected from charging terminal 2032; (3) electrical connection of battery set 2042-2 to charging terminal 2032 while battery set 2042-1 is disconnected from charging terminal 2032; and (4) disconnection of all battery sets 2042 from charging terminal 2032. Electrical switching circuitry 2050 is controllably actuatable between each and any of the different states in response to control signals from controller 2040. Any of the motor connection states may be in place during any of the charging terminal connection states. In one example implementation, electrical switching circuitry 2050 opens both positive and negative side contactors of the battery set which is being disconnected from either or both of the electric motor 2030 or the charging terminal 2032.

Controller 2040 is part of a battery management system that manages the operation of batteries 2042. Controller 2040 receives data or signals from the sensors associated with the battery sets 2042 and evaluates such signals to determine whether a fault condition with respect to either the battery sets 2042 exists or is present. In response to a detected fault condition, controller 2040 outputs electrical control signals actuating electric switching circuitry 2050 to a particular one of the motor connection states and one of the charging terminal connection states described above.

Controller 2040 may be operable in one of several user operator selectable modes. In a first mode, controller 2040 may carry out method 1500 pertaining to electric motor connection and disconnection as described above. In a second mode, controller 2040 may carry out method 1800 pertaining to charging terminal connection and disconnection as described above. In a third mode, controller 2040 may carry out method 1900 pertaining to both electric motor connection and disconnection and charging terminal connection and disconnection. In other implementations, controller 2040 may more simply carry out method 1400 and/or method 1700 as described above. In some implementations, controller 2040 may be configured to carry out combinations or portions of the above-described methods 1400, 1500, 1700, 1800 and 1900.

As in systems 1322 and 1622, in system 2022, controller 2040 monitors battery pack 2028 and various components associated with battery pack 2028 to identify faults (described above) with individual battery sets or with particular subsets of the total number of battery sets. In response to a detected fault on one of the particular battery sets or a number of particular battery sets, controller 2040 and electric switching circuitry 2050 may automatically (or in response to operator input/authorization prompted by controller 2040 on operator interface 2038) disconnect those particular battery sets, for which a fault has been identified, from the electric motor 2030.

As described above with respect to method 1500, controller 2040 may further monitor the state of any previously detected fault. In response to the fault (or faults) no longer being present, controller 2040 may automatically (or in response to operator input/authorization prompted by controller 2040 on operator interface 2038) reconnect the previously disconnected battery set or sets 2042 to the electric motor 2030. As described above with respect to method 1500, such reconnection by the controller 2040 may be contingent upon a controller monitored voltage difference between the different battery sets 2042.

In some implementations, the voltage of each currently disconnected individual battery set 2042 is compared to an average voltage of the currently connected battery sets of pack 2028. In some implementations, the voltage of each currently disconnected individual battery sets 2042 is compared to the voltage of the individual currently connected battery set 2042 having a voltage closest to that of the currently disconnected individual battery sets 2042. In some implementations, the voltage of each currently disconnected individual battery sets 2042 is compared to the voltage of the individual currently connected battery set 2042 having a voltage most different than that of the currently disconnected individual battery sets 2042.

In response to the voltage difference not exceeding the predetermined voltage difference threshold, the currently disconnected battery may be reconnected to the electric motor 2030. In response to the currently disconnected battery set having a voltage greater than the voltage of the connected battery sets and the voltage difference exceeding the predetermined voltage difference threshold, the currently disconnected battery may be connected to the electric motor 2030 and at least one of the currently connected battery sets may be disconnected from the electric motor. In response to the currently disconnected battery set having a voltage less the voltage of the connected battery sets and the voltage difference exceeding than the predetermined voltage difference threshold, the currently disconnected battery may be maintained in a disconnected state from the electric motor 2030. In some implementations, each individual battery set 2042 or particular groups of battery sets 2042 (where vehicle 2020 includes more than two battery sets) may have different associated voltage difference thresholds for used by controller 2040 when determining when to reconnect a battery set to electric motor 2030 or when to disconnect a battery set 2042 from electric motor 2030.

Controller 2040 and electric switching circuitry 2050 of system 2022 are further configured to selectively and individually disconnect and connect the battery sets 2042 to charging terminal 2032 based upon a detected fault in at least one of the battery sets 2042. In the example illustrated, medium or memory 1358 may contain instructions directing processor 1356 to carry out the example method 1700 shown in FIG. 5.

In some implementations, the fault condition which may result in one of the battery sets 2042 being automatically disconnected from the charging terminal 2032 is not limited to a temperature value exceeding a predetermined temperature threshold. In some implementations, the fault condition may comprise a voltage value associated with one of the battery sets that exceeds a predetermined maximum voltage threshold or that falls below a predetermined minimum voltage threshold. The voltage value may be a voltage value for an individual battery cell of a battery set 2042. The voltage value may be an output voltage for a battery set. In some implementations, the fault condition may comprise a battery sets cell voltage sampling line break. In some implementations, the fault condition may comprise a battery sets cell temperature sampling break. In some implementations, the fault condition may comprise an internal communication loss within a battery management system. In some implementations, the fault condition may comprise a communications loss between the battery management system and a vehicle control unit. In some implementations, the fault condition may comprise an electrical current associated with a battery set failing to satisfy a predetermined criterion. In some implementations, the fault condition may comprise a failure of a relay associated with a battery set. In yet other implementations, the fault condition may comprise a fault that is 100% power derating. In some implementations, a battery set may be automatically disconnected from the electric motor in response to one or more of the above describe faults occurring or being present.

In some implementations, controller 2040 may automatically limit power consumption by components of the vehicle 2020 in response to an identified fault condition and a disconnection of a battery set from the electric motor. In some implementations, the operator may be notified of the component for which power consumption is limited via operator interface 2038. For example, in some implementations, the component for which power is limited may comprise hydraulic pump 2034 electrically powered by the electric motor 2030 or the electric motor 2030 itself. In such implementations, controller 2040 may remove the limit in response to reconnection of the previously disconnected battery set to the electric motor 2030. In some implementations, rather than automatically switching the connection of battery sets 2042 to electric motor 2030, controller 2040 may prompt an operator to confirm or authorize such a switching operation through the use of operator interface 2038.

Although FIGS. 8 and 9 illustrate vehicle 2020 as comprising a pair of battery sets 1642, in other implementations, vehicle 2020 may include more than two battery sets such as described above with respect to vehicle 1620. In such implementations, the controller 2040 and electrical switching circuitry 2050 may automatically (or in response to operator authorization prompted by controller output notifications) individually connect and disconnect one or more individual battery sets (from amongst more than two battery sets), to and from the electric motor and/or the charging terminal, based upon a detected fault on any of the more than two battery sets. Likewise, reconnection of a currently disconnected battery set or reconnection of multiple currently disconnected battery sets (from amongst more than two battery sets) by the controller and electric switching circuitry may be based upon the relative voltages or other relative parameters between and amongst the individual battery sets of the more than two battery sets.

Although the claims of the present disclosure are generally directed to a battery pack auto sensing and switching system that automatically electrically disconnects a battery set of a larger battery pack from an electric motor in response to a fault condition, the present disclosure is additionally directed to the features set forth in the following definitions.

Definition 1. A battery pack auto sensing and switching system comprising:
a vehicle comprising:
   an electric motor to propel the vehicle;
   a battery pack comprising;
      a first battery set; and
      a second battery set;
   a controller configured to:
      concurrently electrically connect the first battery set and the second battery set to the electric motor; and
      to determine a fault condition with respect to the first battery set and in response to the fault condition, electrically disconnect the first battery set from the electric motor.

Definition 2. The system of Definition 1, wherein the controller is further configured to monitor presence of the fault condition and in response to the fault condition no longer being present, reconnect the first battery set to the electric motor.

Definition 3. The system of Definition 1, wherein the controller is configured to:
monitor presence of the fault condition;
monitor a first voltage of the first battery set and a second voltage of the second battery set;
monitor a voltage difference between the first voltage and the second voltage;
reconnect the first battery set to the electric motor in response to the fault condition no longer being present and the voltage difference being less than a predetermined voltage difference threshold;
reconnect the first battery set to the electric motor and disconnect the second battery set from the electric motor in response to the fault condition no longer being present and the voltage difference being greater than the predetermined voltage difference threshold and the first voltage being greater than the second voltage; and
maintain connection of the second battery set to the electric motor and maintain disconnection of the first battery set from the electric motor in response to the fault condition no longer being present and the voltage difference being greater than the predetermined voltage difference threshold and the second voltage being greater than the first voltage.

Definition 4. The system of Definition 3, wherein the predetermined voltage difference threshold is at least 2 V and no greater than 5 V.

Definition 5. The system of any of Definitions 1-4, wherein the fault condition comprises a temperature value associated with the first battery set exceeding a predetermined temperature threshold.

Definition 6. The system of any of Definitions 1-4, wherein the fault condition comprises a voltage value associated with the first battery set exceeding a predetermined maximum voltage threshold or falling below a predetermined minimum voltage threshold.

Definition 7. The system of Definition 6, wherein the voltage value is a voltage value of an individual battery cell of the first battery set.

Definition 8. The system of Definition 6, wherein the voltage value is an output voltage of the first battery set.

Definition 9. The system of any of Definitions 1-5, wherein the fault condition comprises a first battery set cell voltage sampling line break.

Definition 10. The system of any of Definitions 1-5, wherein the fault condition comprises a first battery set cell temperature sampling line break.

Definition 11. The system of any of Definitions 1-5, wherein the controller is part of a battery management system and wherein the fault condition comprises an internal communications loss within the battery management system.

Definition 12. The system of any of Definitions 1-5, wherein the controller is part of a battery management system, wherein the vehicle comprises a vehicle control unit and wherein the fault condition comprises a communications loss between the battery management system and the vehicle control unit.

Definition 13. The system of any of Definitions 1-5, wherein the fault condition comprises an electrical current associated with the first battery set failing to satisfy a predefined criterium.

Definition 14. The system of any of Definitions 1-5, wherein the fault condition comprises failure of a relay associated with the first battery set.

Definition 15. The system of any of definitions 1-5, the fault condition comprises any fault that has a 100% power derating.

Definition 16. The system of any of Definitions 1-15, wherein the controller is further configured to limit power consumption by a component of the vehicle in response to disconnection of the first battery set from the electrical motor.

Definition 17. The system of Definition 16, the controller is to notify an operator of the component for which power consumption is limited by the controller.

Definition 18. The system of Definition 16, wherein the component comprises a hydraulic pump electrically powered by the electric motor.

Definition 19. The system of Definition 16, the component comprises the electric motor.

Definition 20. The system of Definition 16, the controller is configured to remove the limit in response to reconnection of the first battery set to the electric motor.

Definition 21. A battery management system for use with a vehicle having a first battery set and a second battery set for independently powering an electric motor to propel the vehicle, the battery management system, the battery management system comprising:
a processing unit;
a non-transitory computer-readable medium containing instructions configured to direct the processing unit to:
   concurrently electrically connect the first battery set and the second battery set to the electric motor; and
   to determine a fault condition with respect to the first battery set and in response to the fault condition, electrically disconnect the first battery set from the electric motor.

Definition 22. The battery management system of Definition 21, wherein the instructions are further configured to direct the processing unit to:
monitor presence of the fault condition and in response to the fault condition no longer being present, reconnect the first battery set to the electric motor.

Definition 23. The battery management system of Definition 21, wherein the instructions are further configured to direct the processing unit to: monitor presence of the fault condition;
monitor a first voltage of the first battery set and a second
voltage of the second battery set;
monitor a voltage difference between the first voltage and the second voltage;
reconnect the first battery set to the electric motor in response to the fault condition no longer being present and the voltage difference being less than a predetermined voltage difference threshold;
reconnect the first battery set to the electric motor and disconnect the second battery set from the electric motor in response to the fault condition no longer being present and the voltage difference being greater than the predetermined voltage difference threshold and the first voltage being greater than the second voltage; and
maintain connection of the second battery set to the electric motor and maintain disconnection of the first battery set from the electric motor in response to the fault condition no longer being present and the voltage difference being greater than the predetermined voltage difference threshold and the second voltage being greater than the first voltage.

Definition 24. A method for managing a battery pack of an electrical vehicle comprising a first battery set and a second battery set configured to independently power and electric battery for propelling the electrical vehicle, the method comprising:
concurrently electrically connecting the first battery set and the second battery set to the electric motor; and
   determining a fault condition with respect to the first battery set and in response to the fault condition,
electrically disconnecting the first battery set from the electric motor.

Definition 25. The method of Definition 24 further comprising:
monitoring presence of the fault condition and in response to the fault condition no longer being present, reconnect the first battery set to the electric motor.

Definition 26. The method of Definition 24 further comprising:
monitoring presence of the fault condition;
monitoring a first voltage of the first battery set and a second voltage of the second battery set;
monitoring a voltage difference between the first voltage and the second voltage;
reconnecting the first battery set to the electric motor in response to the fault condition no longer being present and the voltage difference being less than a predetermined voltage difference threshold;
reconnecting the first battery set to the electric motor and disconnecting the second battery set from the electric motor in response to the fault condition no longer being present and the voltage difference being greater than the predetermined voltage difference threshold and the first voltage being greater than the second voltage; and
maintaining connection of the second battery set to the electric motor and maintaining disconnection of the first battery set from the electric motor in response to the fault condition no longer being present and the voltage difference being greater than the predetermined voltage difference threshold and the second voltage being greater than the first voltage.

Definition 27. A battery pack auto sensing and switching system comprising:
a vehicle comprising;
   an electric motor to propel the vehicle;
   a battery pack comprising battery sets;
   a controller configured to:
      concurrently electrically connect the battery sets to the electric motor; and
      to determine a fault condition with respect to a particular battery set of the battery sets and in response to the fault condition, electrically disconnect the particular battery set from the electric motor.

Definition 28. A battery pack auto sensing and switching system comprising:
a vehicle comprising;
   a charging terminal for connection to an external power source;
   a battery pack comprising battery sets;
   a controller configured to:
      concurrently electrically connect the battery sets to the charging terminal; and
      to determine a fault condition with respect to a particular battery set of the battery sets and in response to the fault condition, electrically disconnect the particular battery set from the charging terminal.

Definition 29. The battery pack auto sensing and switching system of Definition 28, wherein the controller is configured to connect a currently disconnected battery set to the charging terminal in response to absence of the fault condition with respect to the disconnected battery and a difference between a voltage of the disconnected battery set and other individual battery sets being less than a predefined voltage difference threshold.

Definition 30. The battery pack auto sensing and switching system of Definition 28, wherein the controller is configured to monitor a voltage difference between individual battery sets and is configured to disconnect those battery sets from the charging terminal that have voltage levels differing from an average of voltage levels of remaining battery sets by an amount exceeding a predefined voltage difference threshold.

Definition 31. A battery pack auto sensing and switching system comprising:
a vehicle comprising;
   an electric motor to propel the vehicle;
   a battery pack comprising multiple battery sets;
   a charging terminal for individually charging battery sets of the multiple battery sets;
   a controller configured to:
      detect faults on individual battery sets of the multiple battery sets;
      monitor a voltage difference between and amongst the individual battery sets of the multiple battery sets;
      selectively electrically connect and disconnect individual battery sets of the multiple battery sets (1) to and from the electric motor and (2) to and from the charging terminal, based upon a detected fault on the individual battery sets and the voltage differences between and amongst the individual battery sets.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A battery pack auto sensing and switching system comprising:
a vehicle comprising;
an electric motor to propel the vehicle;
a battery pack comprising:
a first battery set; and
a second battery set;
a controller configured to:
concurrently electrically connect the first battery set and the second battery set to the electric motor; and
to determine a fault condition with respect to the first battery set and in response to the fault condition, electrically disconnect the first battery set from the electric motor.

2. The system of claim 1, wherein the controller is further configured to monitor presence of the fault condition and in response to the fault condition no longer being present, reconnect the first battery set to the electric motor.

3. The system of claim 1, wherein the controller is configured to:
monitor presence of the fault condition;
monitor a first voltage of the first battery set and a second voltage of the second battery set;
monitor a voltage difference between the first voltage and the second voltage;
reconnect the first battery set to the electric motor in response to the fault condition no longer being present and the voltage difference being less than a predetermined voltage difference threshold;
reconnect the first battery set to the electric motor and disconnect the second battery set from the electric motor in response to the fault condition no longer being present and the voltage difference being greater than the predetermined voltage difference threshold and the first voltage being greater than the second voltage; and
maintain connection of the second battery set to the electric motor and maintain disconnection of the first battery set from the electric motor in response to the fault condition no longer being present and the voltage difference being greater than the predetermined voltage difference threshold and the second voltage being greater than the first voltage.

4. The system of claim 1, wherein the fault condition comprises a temperature value associated with the first battery set exceeding a predetermined temperature threshold.

5. The system of claim 1, wherein the fault condition comprises a voltage value associated with the first battery set exceeding a predetermined maximum voltage threshold or falling below a predetermined minimum voltage threshold.

6. The system of claim 5, wherein the voltage value is a voltage value of an individual battery cell of the first battery set.

7. The system of claim 5, wherein the voltage value is an output voltage of the first battery set.

8. The system of claim 1, wherein the controller is part of a battery management system and wherein the fault condition comprises an internal communications loss within the battery management system.

9. The system of claim 1, wherein the controller is part of a battery management system, wherein the vehicle comprises a vehicle control unit and wherein the fault condition comprises a communications loss between the battery management system and the vehicle control unit.

10. The system of claim 1, wherein the fault condition is selected from a group of fault conditions consisting of: an electrical current associated with the first battery set failing to satisfy a predefined criterium; failure of a relay associated with the first battery set; and any fault that has a 100% power derating; a first battery set cell voltage sampling line break; and a first battery set cell temperature sampling line break.

11. The system of claim 1, wherein the controller is further configured to apply a limit to power consumption by a component of the vehicle in response to disconnection of the first battery set from the electrical motor.

12. The system of claim 11, the controller is to notify an operator of the component for which power consumption is limited by the controller.

13. The system of claim 11, wherein the component is selected from a group of components consisting of: a hydraulic pump electrically powered by the electric motor; and the electric motor.

14. The system of claim 11, wherein the controller is configured to remove the limit in response to reconnection of the first battery set to the electric motor.

15. The system of claim 1, wherein the vehicle further comprises a charging terminal configured for charging the first battery set and the second battery set and wherein the controller is configured to:
monitor a first voltage of the first battery set and a second voltage of the second battery set;
monitor a voltage difference between the first voltage and the second voltage;
connect the first battery set and the second battery set to the charging terminal in response to the fault condition no longer being present and the voltage difference being less than a predetermined voltage difference threshold;
disconnect the first battery set from the charging terminal and connect the second battery set to the charging terminal in response to the fault condition no longer being present and the voltage difference being greater than the predetermined voltage difference threshold and the first voltage being greater than the second voltage; and
disconnect the second battery set from the charging terminal and connect the first battery set to the charging terminal in response to the fault condition no longer being present and the voltage difference being greater than the predetermined voltage difference threshold and the second voltage being greater than the first voltage.

16. A battery pack auto sensing and switching system comprising:
a vehicle comprising;
a charging terminal for connection to an external power source;
a battery pack comprising battery sets;
a controller configured to:
concurrently electrically connect the battery sets to the charging terminal; and
to determine a fault condition with respect to a particular battery set of the battery sets and in response to the fault condition, electrically disconnect the particular battery set from the charging terminal.

17. The battery pack auto sensing and switching system of claim 16, wherein the controller is configured to connect a currently disconnected battery set to the charging terminal in response to absence of the fault condition with respect to the disconnected battery and a difference between a voltage of the disconnected battery set and other individual battery sets being less than a predefined voltage difference threshold.

18. The battery pack auto sensing and switching system of claim 16, wherein the controller is configured to monitor a voltage difference between individual battery sets and is configured to disconnect those battery sets from the charging terminal that have voltage levels differing from an average of voltage levels of remaining battery sets by an amount exceeding a predefined voltage difference threshold.

19. A battery management system for use with a vehicle having a first battery set and a second battery set for independently powering an electric motor to propel the vehicle, the battery management system, the battery management system comprising:
a processing unit;
a non-transitory computer-readable medium containing instructions configured to direct the processing unit to:
concurrently electrically connect the first battery set and the second battery set to the electric motor; and
to determine a fault condition with respect to the first battery set and in response to the fault condition, electrically disconnect the first battery set from the electric motor.

20. The battery management system of claim 19, wherein the instructions are further configured to direct the processing unit to:
monitor presence of the fault condition and in response to the fault condition no longer being present, reconnect the first battery set to the electric motor.
